(19) United States
(12) Patent Application Publication
(10) Pub. No.: US 2014/0229233 A1
(43) Pub. Date: Aug. 14, 2014

(54) CONSUMER SPENDING FORECAST SYSTEM AND METHOD

(71) Applicant: MASTERCARD INTERNATIONAL INCORPORATED, (US)

(72) Inventor: Po Hu, Norwalk, CT (US)

(73) Assignee: MASTERCARD INTERNATIONAL INCORPORATED, Purchase, NY (US)

(21) Appl. No.: 13/766,565

(22) Filed: Feb. 13, 2013

(51) Int. Cl. G06Q 30/02

(52) U.S. Cl. CPC G06Q 30/0202
USPC 705/7.31

(57) ABSTRACT

A system and method of forecasting consumer spending including accumulating a database of spending data, the database including data from a plurality of merchants and transaction devices, conducting a time series analysis of the spending data using, communicating the results of the time series analysis to a spending forecaster, the forecaster applying an algorithm to the time series results to predict future spending, and generating an output of the future spending prediction.

### FIELD OF THE INVENTION

The present invention relates to a system and method for predicting spending and, more particularly, to a system and method for predicting consumer spending using time series data.

### BACKGROUND

Purchase transaction is one of the most important factors to our society. Vast consumer payment information collected by a bank, or a credit card issuer, or a credit card company, or any form of payment business, can be greatly useful for presenting the economic strength, consumer demanding, inventory planning, and so on. There are billions of transactions happened in each day and the value of collecting and processing the big data, making correct forecasting, and set optimal economic plans and strategies are crucial to many of government organizations and companies.

Knowledge of consumer spending is a very important piece of information for businesses. Knowing how much consumers are spending and in what retail category and when spending occurs enables business to allocate their marketing resources to gain greater market share. Such information allows businesses to determine which goods or services are gaining traction in the marketplace and how a market is developing.

Based on such information, it is desirable to predict future consumer spending so that marketing efforts, manufacturing activities and inventories can be controlled to maximize efficiency. Accordingly, it is very desirable to try and accurately forecast consumer spending for different segments of the market. Attempts to predict consumer spending are known in the art.

However each of the methods of consumer spending forecasting are hampered by the limited information relied upon. Businesses typically only have data relating to the various segments of the market based on the sales they have made. Accurate and meaningful data for a market segment as a whole is difficult to obtain. Even if such information is obtained it only reflects what has happened in the past. While year to year trends can be established, and other historical factors considered to generate a prediction, the accuracy of such forecasts is limited.

Accordingly, it would be desirable to provide a system for accurately forecasting consumer spending which takes into account actual past spending in addition to consumer surveys.

### SUMMARY

The present invention provides a method of forecasting consumer spending including:

accumulating a database of spending data, the database including data from a plurality of merchants and transaction devices
conducting a time series analysis of the spending data using a processor;
communicating the results of the time series analysis to a spending forecaster;
the forecaster applying an algorithm to the time series results to predict future spending; and
generating an output of the future spending prediction.

The present invention further provides a system for forecasting consumer spending including a database of spending data. The database includes data from a plurality of merchants and transaction devices. A time series generator is in communication with the database. The time series generator conducts a time series analysis of the spending data. A spending forecaster is in operative communication with the time series generator. The forecaster applies an algorithm to the time series results to predict future spending, and the forecaster generates an output of the future spending prediction.

The present invention still further provides a computer-readable distribution medium encoding a computer program of instructions for executing a computer process, the process comprising:
accumulating a database of spending data, the database including data from a plurality of merchants and transaction devices
conducting a time series analysis of the spending data using;
communicating the results of the time series analysis to a spending forecaster;
the forecaster applying an algorithm to the time series results to predict future spending; and
generating an output of the future spending prediction.

### BRIEF DESCRIPTION OF THE DRAWINGS

FIG. 1 is a block diagram of payment transaction system in accordance with the present invention.

FIG. 2 is a time series sequence chart.

FIG. 3 is block diagram of a forecast system.

FIG. 4 is a block diagram of a forecaster.

FIG. 5 is a flow chart of a method for predicting consumer spending.

FIG. 6 is a block diagram of an embodiment of a machine in the form of a computing system within which a set of instructions that, when executed, may cause the machine to perform any one or more of the methodologies disclosed herein.

### DETAILED DESCRIPTION

The present invention provides a method and system for forecasting consumer spending based on payment transactions. The payment transactions may be in the form of creditor debit card purchase made over a payment network such as the MasterCard® network. Such purchases generate transaction data that is stored in a transaction database of the payment network.

The present invention provides a technique set up for utilizing consumer data for variety forecasts. An exemplary embodiment of a method (which can be computer-implemented), according to one aspect of the invention, includes the steps of obtaining and aggregate data for a plurality of data sources about consumer transactions by issuing country, issuing bank, transaction store or industry, payment channel, and method, and so on. The aggregated data is processed further, as conducted by the system user, to create a single or multiple target time series data. Combined with a plurality of event time series data and the target time series data, the system will automatically produce a set of optimal forecasts for the future values of the target time series. The system makes forecasts using machine learning techniques and pattern detection algorithms about seasonality, cyclic, trend, auto-regression, moving averages, event correlation, and so on. The system also use validate forecast outputs by back test sample and select optimal forecast approaches.

The target time series can be multiple coupled time series data streams. For example but not limited by it, time series of industries in traveling, accommodation, and fuel are highly correlated or coupled; Forecast will lose accuracy if an important correlated time series is ignored.

The system also uses external economic and event data points for complementary information outside of consumer demands and supplies.

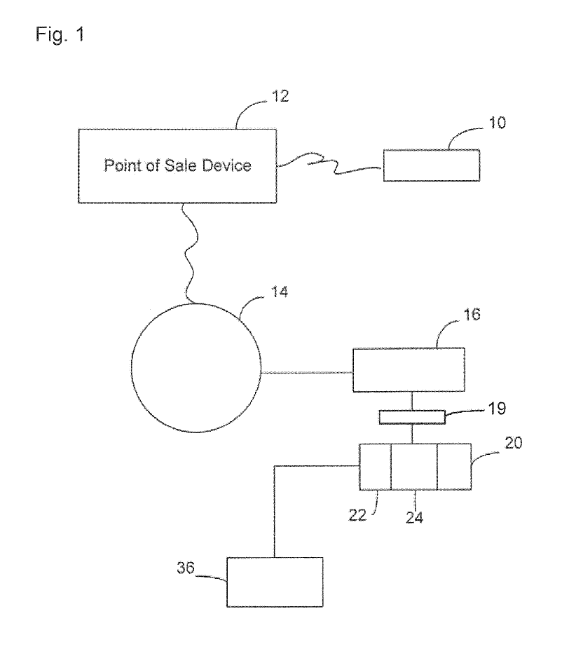

With reference to FIG. 1, when a payment transaction occurs a payment device 10 communicates with a point of sale device 12. The payment device may be a credit card, debit card, prepaid card, RFID chip, or the like. The point of sale device may be a payment terminal in a store or a device associated with an online transaction. When a purchase is made, the spending transaction data is transmitted over a payment network 14. The spending transaction data may include parameters for each payment transaction such as merchant location, transaction amount, and category of goods and services. For example, information as to whether the purchase was for home improvement, clothing, automotive, food, restaurant services, or travel can be gathered and stored. The transaction location may be generated by a point of sale (“POS”) device of a type know in the art. When a payment transaction is made, the payment network 14 receives information from the point of sale device 12 including the ID of the merchant the zip code of the merchant and the amount spent. The transaction data is stored in a transaction database 16. The transaction database 16 of the payment network is unique in that it is not limited to any one merchant or chain of merchants. The transaction database 16 will store data regarding payment transactions across a wide spectrum including many merchants and many market segments. The transaction data can be tracked daily. Such a comprehensive transaction database allows for reliable and robust forecasts to be generated. Using aggregated actual payment data can more accurately present consumer demands and supplies than use a survey, and therefore can produce better forecasts.

The information in the transaction database may be aggregated to group certain database information together. The detail of the transaction data information can be aggregated to allow for the forecasting of spending for very specific market segments. For example, one could forecast spending on restaurants in New York City, or spending on home improvements in Orlando, Fla. This market and location specific spending is very useful to merchants since it is directly relevant to their precise market. The database information can be aggregated in many ways depending on what forecast is desired.

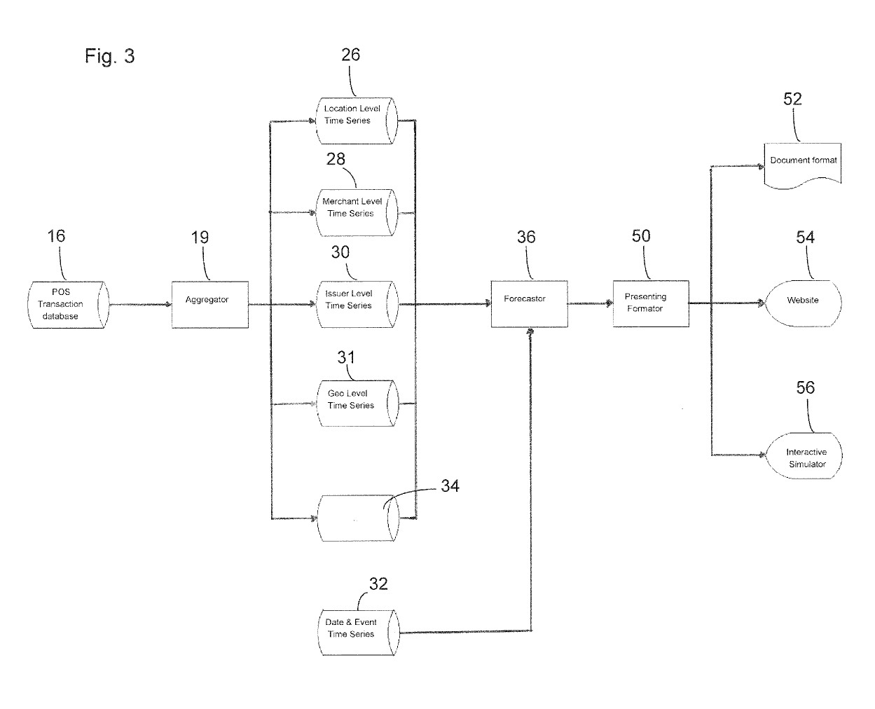

With reference to FIGS. 1 and 3, the transaction data received from the POS devices is operated upon by an Aggregator 19. The Aggregator 19 groups the information in the transaction database depending on the forecast scope desired. The Aggregator 19 can therefore be used to define the scope of the forecast. For example, if one seeks to forecast spending in home improvement stores in Orlando Fla., the aggregator will be configured to group the data from home improvement stores having a location in or around Orlando. The aggregated data is then communicated to and operated upon by a time series generator 20. The generator 20 may include a processing device 22 and memory 24 in operative communication with transaction database 16. The processing device 22 may include one or more processors, memory and other hardware and/or software.

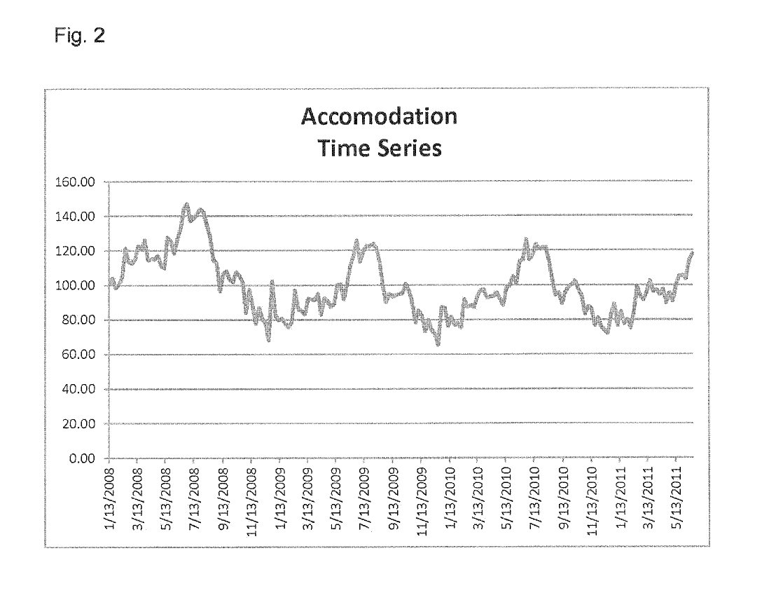

Time series data is then generated by the processor. A time series is a sequence of data points, measured typically at successive time instants spaced at uniform time intervals. Time series analysis comprises methods for analyzing time series data in order to extract meaningful statistics and other characteristics of the data. Time series forecasting is the use of a model to predict future values based on previously observed values. Time series are very frequently plotted via line charts. An example of a chart showing a time series sequence for accommodations is shown in FIG. 2 with sales data on the Y axis and time on the X axis. The system is flexible to construct different level target time series. Examples are the target time series can be created at a specific geographic area, or a store or industry, or particular to a specific payment method like online purchases.

With reference to FIG. 3, the time series generator 20 can create a time series sequence based on one or more levels of data. Such levels may include a location level 26, a merchant level 28, an issuer level 30, a geographic level 31, and a date and event time level 32. Other time series levels 34 may also be included. The target time series can be multiple coupled time series data streams. For example but not limited by it, time series of industries in traveling, accommodation, and fuel are highly correlated or coupled. Therefore, time series for these transactions can be aggregated.

The location level 26 may include the location of a particular store at a particular location.

The merchant level 28 may include specific information regarding a chain of merchants. This level would include sales of a particular chain of stores. Therefore, spending at a specific chain of merchants or stores is used to create time series data. By knowing the particular merchant, information regarding the type of good/services offered is also known. As in the above example, the merchant level may be stores selling home improvement goods in which case the spending over time in such stores in tracked over time to create time series data.

The issuer level time series 30 may track spending over time based on the transaction device issuer of the transaction device. The issuer may include a bank, financial institution or other entity.

The geographic level 31 may be the location of the transactions. This can be obtained for example by the zip code of the retailer. Depending on the scope of the forecast the location could be a particular city or town or it could be a state or region.

The system may also use external economic and event data points for complementary information outside of consumer demands and supplies. Data influencing a spending forecast can come from sources outside of the transaction database. A date and event level time series 32 can include events that may affect spending, and therefore, the spending forecast. For example, if there are negative economic, weather, and/or political developments that may affect spending, such events can be included in the time series data.

The time series generator can include one of the above referenced levels or a combination of them. For example, the time series generator may use data based on the merchant level and the geographic level and generate a time series data based on these levels.

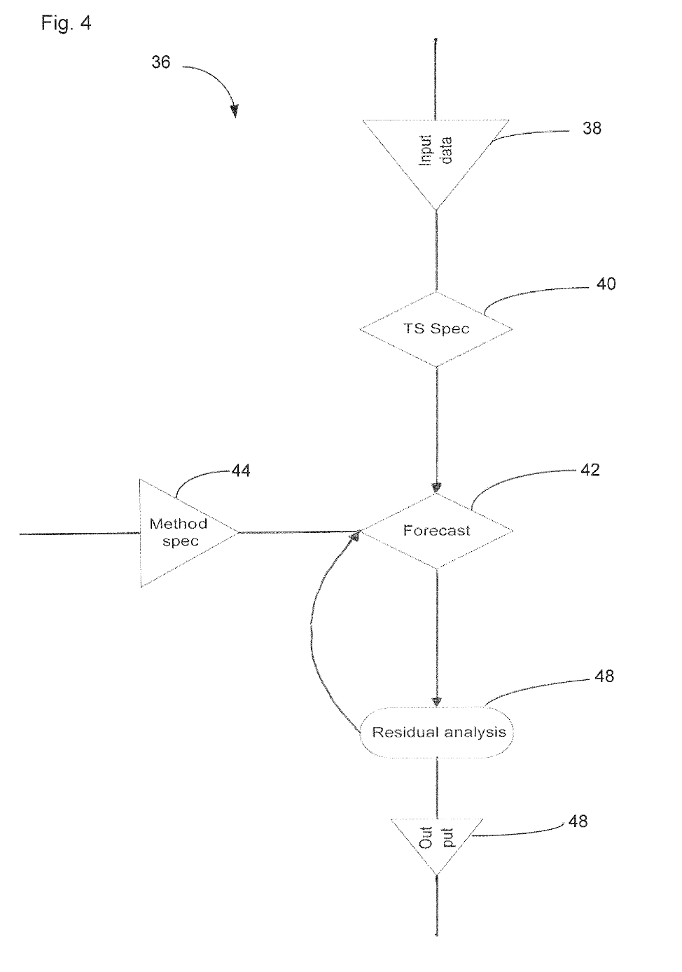

With reference to FIG. 4, the time series data is then operatively communicated to the forecaster 36. The forecaster 36 can be configured to output a spending forecast within predetermined parameters. For example, if one wants to obtain a prediction for spending on home improvement goods in the Northeast, the times series data relevant to that forecast will be used. The forecaster 36 may be in the form of a processor with associated memory, software and hardware. Input data module 38 transmits time series data to a Time Series Specification module 40. The input data could be multiple sets of time series data. The Time Series Specification module 40 is configured to sort through the time series data and acts as a filter to permit only the input data relevant to the desired forecast scope to be passed on for further processing.

Time Series Specifications module 40 communicates with a forecast module 42. The forecast module 42 includes an algorithm or model for generating the forecast. The forecast module may be operably connected to a Method Specification module 44 which determines the forecast model or algorithm to be used responsive to a desired forecast scope. The particular statistical forecast model may be dependent on the forecast output desired. One possible forecast model is Auto-Regressive Integrated Moving Average (“ARIMA”), which is a class of known models for forecasting a time series. Variations include random-walk and random-trend models, autoregressive models, and exponential smoothing models (i.e., exponential weighted moving averages). A user may interface with the Time Series Specifications module 40 and select and input the particular forecast model desired. The forecast model 42 may be varied in order to enhance the accuracy of the forecast.

The forecast module 42 generates the spending forecast for a particular time period. This forecast may undergo review by a residual analysis module 46. The forecast can be generated for a test period of time in the past. Actual data for that test time period is known. The residual module compares the generated forecast with the actual data. The forecast delta between the forecast and actual data is then fed back to the forecast module. The forecast model 42 may then be modified or changed in order to reduce the forecast delta and enhance the accuracy of the forecast. When the forecast delta falls within an acceptable range, the forecast is communicated by an output module 48. The forecast generator 36 can then be used to provide predictions of future spending.

In one embodiment, the forecast generator may be used to determine gross dollar volumes (“GDV”). The GDV is the total money flow, or value of overall transactions using the company's credit cards in a given period.

With further reference to FIG. 3, the output module is in communication with a presenting formatter 50. The formatter 50 configures the forecast output for a predetermined manner of display. For example, the forecast may be in the form of a document 52, website page 54, etc. The forecast may even be presented in an interactive simulator 56. The interactive simulator may allow a user to change input data to see the effect on the forecast. For example, if a manager of a store wants to see the effect of increasing the number of sale promotions, the manager can change the data to reflect the increase and see what if any effect on sales.

The system may then perform pattern detection. By analyzing the data patterns trends, for example, cyclic and seasonal trends can be detected. Forecasts as to spending can also be made.

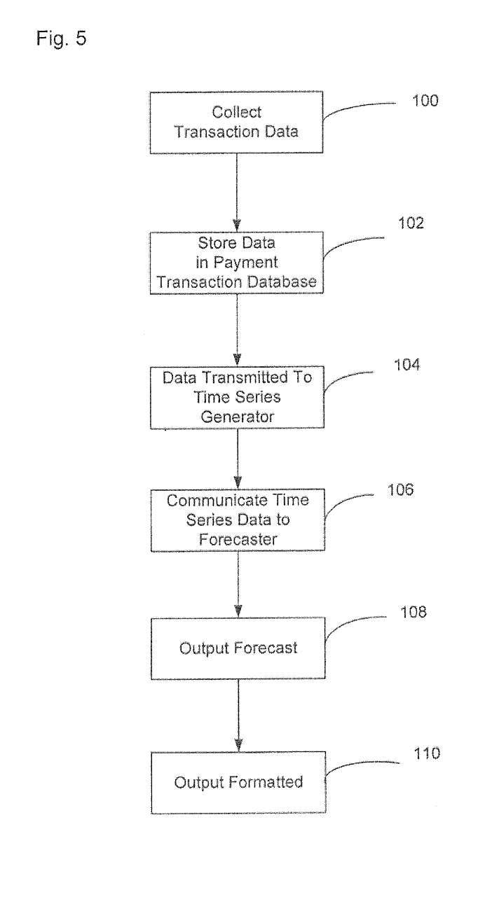

With reference to FIG. 5, in operation, payment transaction data is collected from point of sale devices during a payment transaction 100. The data is transmitted over a payment network and stored in a payment transaction database 102. This database includes transaction data from multiple retailers, service providers and the like and is not limited to one entity. Therefore, the database has a broad spectrum of payment data. The payment transaction data is transmitted to a time series generator 104. In the time series generator, a time series sequence can be generated for different parameters, such as location, product, issue and date and event. The result of these time series sequences are communicated to the forecaster 106. In the forecaster, the data is filtered by a time series specification module based on the desired forecast parameters. A forecast module performs an algorithm to generate a spending forecast. The algorithm is selected by the method specification module. The output of the forecast module is reviewed by the residual analysis module wherein a forecast delta between the forest output and actual data is generated. The residual module communicates the delta to the forecast module and the forecast is adjusted. When the forecast delta is within an acceptable range, the forecaster can be output and used to provide predictions of future spending 108. The output form the forecaster may be communicated to the output formatter so that the output may be presented in a desired manner 110.

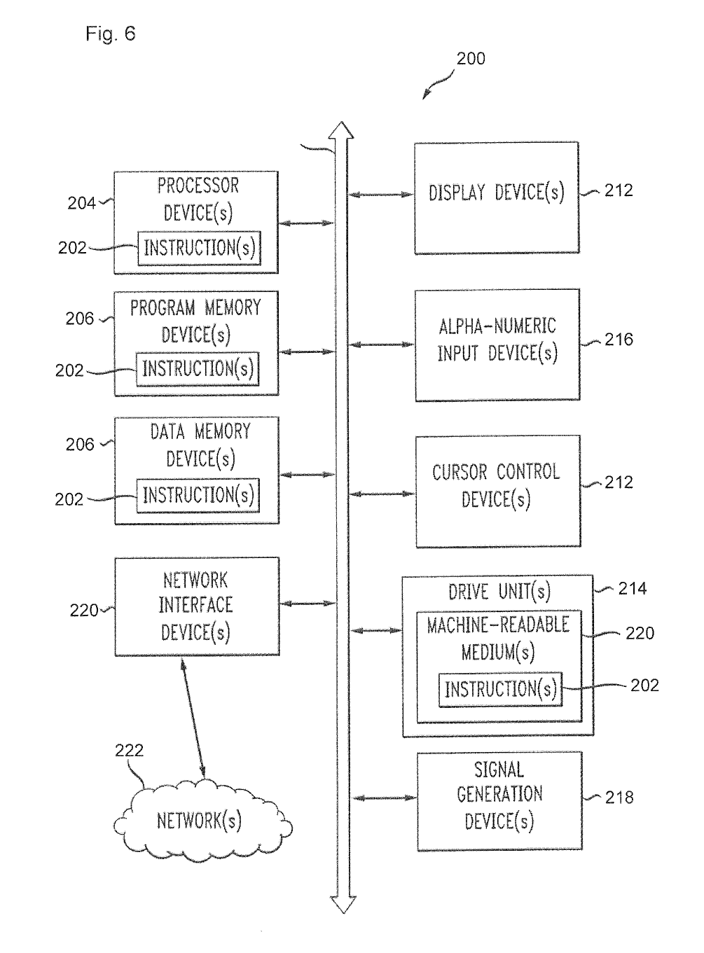

With reference to FIG. 6 is a block diagram of an embodiment of a machine in the form of a computing system 200, within which a set of instructions 202, that when executed, may cause the machine to perform any one or more of the methodologies disclosed herein. In some embodiments, the machine operates as a standalone device. In some embodiments, the machine may be connected (e.g., using a network) to other machines. In a networked implementation, the machine may operate in the capacity of a server or a client user machine in a server-client user network environment. The machine may comprise a server computer, a client user computer, a personal computer (PC), a tablet PC, a Personal Digital Assistant (PDA), a cellular telephone, a mobile device, a palmtop computer, a laptop computer, a desktop computer, a communication device, a personal trusted device, a web appliance, a network router, a switch or bridge, or any machine capable of executing a set of instructions (sequential or otherwise) that specify actions to be taken by that machine.

The computing system 200 may include a processing device(s) 204 (e.g., a central processing unit (CPU), a graphics processing unit (GPU), or both), program memory device(s) 206, and data memory device(s) 208, which communicate with each other via a bus 210. The computing system 200 may further include display device(s) 212 (e.g., liquid crystals display (LCD), a flat panel, a solid state display, or a cathode ray tube (CRT)). The computing system 200 may include input device(s) 216 (e.g., a keyboard), cursor control device(s) 212 (e.g., a mouse), disk drive unit(s) 214, signal generation device(s) 218 (e.g., a speaker or remote control), and network interface device(s) 220.

The disk drive unit(s) 214 may include machine-readable medium(s) 220, on which is stored one or more sets of instructions 202 (e.g., software) embodying any one or more of the methodologies or functions disclosed herein, including those methods illustrated herein. The instructions 202 may also reside, completely or at least partially, within the program memory device(s) 206, the data memory device(s) 208, and/or within the processing device(s) 204 during execution thereof by the computing system 200. The program memory device(s) 206 and the processing device(s) 204 may also constitute machine-readable media. Dedicated hardware implementations 204, but not limited to, application specific integrated circuits, programmable logic arrays, and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but are not limited to, distributed processing or component/object distributed processing, parallel processing, or virtual machine processing which can also be constructed to implement the methods described herein.

The present embodiment contemplates a machine-readable medium or computer-readable medium containing instructions 202, or that which receives and executes instructions 202 from a propagated signal so that a device connected to a network environment 222 can send or receive voice, video or data, and to communicate over the network 222 using the instructions 202. The instructions 202 may further be transmitted or received over a network 222 via the network interface device(s) 220. The machine-readable medium may also contain a data structure for storing data useful in providing a functional relationship between the data and a machine or computer in an illustrative embodiment of the disclosed systems and methods.

While the machine-readable medium 220 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform anyone or more of the methodologies of the present embodiment. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives that is considered a distribution medium equivalent to a tangible storage medium. Accordingly, the embodiment is considered to include anyone or more of a tangible machine-readable medium or a tangible distribution medium, as listed herein and including art-recognized equivalents and successor media, in which the software implementations herein are stored.

Although the present specification describes components and functions implemented in the embodiments with reference to particular standards and protocols, the disclosed embodiment are not limited to such standards and protocols.

In a particular non-limiting, example embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods, functions or logic described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods, functions or logic described herein.

It should also be noted that software which implements the disclosed methods, functions or logic may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although specific example embodiments have been described, it will be evident that various modifications and changes may be made to these embodiments without departing from the broader scope of the inventive subject matter described herein. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A method of forecasting consumer spending comprising:
accumulating a database of spending data, the database including data from a plurality of merchants and transaction devices conducting a time series analysis of the spending data using a processor;
communicating the results of the time series analysis to a spending forecaster;
the forecaster applying an algorithm to the time series results to predict future spending using a processor; and
generating an output of the future spending prediction.

2. The method as defined in claim 1, wherein the time series analysis is conducted by a time series generator.

3. The method as defined in claim 2, wherein the time series generator generates time series data based on a predetermined parameter.

4. The method as defined in claim 3, wherein the predetermined parameters are one of a purchase location, a transaction device type, a transaction device issuer, and a date.

5. The method as defined in claim 1, wherein the forecaster includes a time series specification element for filtering the time series data responsive to a predetermined spending forecast scope.

6. The method as defined in claim 1, wherein the spending forecaster includes a forecast processing device in communication with the time series specification element, the forecast processor running a prediction algorithm.

7. The method as defined in claim 6, wherein the forecaster includes a method specification element in communication with the forecast processor, the method specification element selecting the particular algorithm responsive to the desired scope of the spending forecast.

8. The method as defined in claim 6, wherein the forecaster includes a residual analysis element which compares a calculated spending forecast with actual spending results and the forecast processor modifies the algorithm responsive to the comparison to improve the accuracy of the forecast.

9. The method as defined in claim 6, wherein the database is in communication with a payment network.

10. The method as defined in claim 6, wherein the database includes spending data parameters for each payment transaction, the parameters selected from the group consisting of merchant location, transaction amount, and category of goods and services.

11. A system for forecasting consumer spending comprising:
a database of spending data, the database including data from a plurality of merchants and transaction devices;
a time series generator in communication with the database, the time series generator including a processor and conducting a time series analysis of the spending data; and
a spending forecaster in operative communication with the time series generator, the forecaster applying an algorithm to the time series results to predict future spending, and the forecaster generating an output of the future spending prediction.

12. The system as defined in claim 11, wherein time series generator generates time series data based on a predetermined parameters selected from the group consisting of purchase location, transaction device type, transaction device issuer, and date.

13. The system as defined in claim 11, wherein the spending forecaster includes a forecast processing device in communication with the time series specification element, the forecast processor running a prediction algorithm.

14. The system as defined in claim 11, wherein the forecaster includes a time series specification element for filtering the time series data responsive to a predetermined spending forecast scope.

15. The system as defined in claim 11, wherein the spending forecaster includes a method specification element in communication with the forecast processor, the method specification element selecting the particular algorithm responsive to the scope of the spending forecast.

16. The system as defined in claim 11, wherein the forecaster includes a residual analysis element which compares a calculated spending forecast with actual spending results and the forecast processor modifies the algorithm responsive to the comparison to improve the accuracy of the forecast.

17. The system as defined in claim 11, wherein the forecaster is in operative communication with a presenting formatter which configures forecast data to a predetermined format for viewing.

18. The system as defined in claim 11, wherein forecaster includes a processor for performing the forecast algorithm.

19. The system as defined in claim 11, wherein the database is in communication with a payment network.

20. The system as defined in claim 19, wherein the database includes spending data parameters for each payment transaction, the parameters selected from the group consisting of merchant location, transaction amount, and category of goods and services.

21. A computer-readable distribution medium encoding a computer program of instructions for executing a computer process, the process comprising:
accumulating a database of spending data, the database including data from a plurality of merchants and transaction devices
conducting a time series analysis of the spending data using;
communicating the results of the time series analysis to a spending forecaster;
the forecaster applying an algorithm to the time series results to predict future spending; and
generating an output of the future spending prediction.
